(19) United States
(12) Patent Application Publication
(10) Pub. No.: US 2008/0030616 A1
(43) Pub. Date: Feb. 7, 2008

(54) DISPLAY SYSTEM, TELETEXT STORAGE DEVICE, AND METHOD THEREOF

(75) Inventor: Yuming Huang, Tainan City (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: MEDIATEK INC., Hsin-Chu City (TW)

(21) Appl. No.: 11/462,543

(22) Filed: Aug. 4, 2006

(51) Int. Cl. H04N 11/00

(52) U.S. Cl. 348/468

(57) ABSTRACT

A display system, a teletext storage device, and a method thereof are provided. The display system comprises the teletext storage device and a monitor. The teletext storage device comprises a decoder, a compressor, a memory, and a decompressor. The decoder decodes a teletext datum. The compressor compresses the decoded teletext datum. The memory then stores the compressed teletext datum. After a page is requested, the decompressor retrieves the page of the compressed teletext datum from the memory and decompresses the page. After, the monitor displays the page.

### CROSS-REFERENCES TO RELATED APPLICATIONS

Not applicable.

### BACKGROUND OF THE INVENTION

1. Field of the Invention

The present invention relates to a display system, a teletext storage device, and a method thereof. More particularly, the present invention relates to a display system, a teletext storage device, and a method for saving memory space.

2. Descriptions of the Related Art

Most TV receivers on the current market comprise a teletext storage device configured to process teletext data attached to a TV program. A teletext service provides real-time information broadcasting while a TV program is running. The real-time information broadcasting comprises, for example, train schedules, breaking news, real-time stock quotes, and weather forecasts, etc.

A teletext datum contains a number of pages, each of which includes information for one screen. Generally speaking, a teletext datum can be divided into eight magazines at most. Each magazine may include up to 100 pages. Therefore, one teletext datum might have 800 pages.

A conventional teletext storage device is shown in FIG. 1. The teletext storage device 1 comprises a decoder 11 and a memory 13. A bitstream 10 carrying a teletext datum is transmitted to the decoder 11 for decoding. A decoded bitstream 12 is outputted to the memory 13 for temporary storage. Once a user requests access to a desired page of the teletext datum, the desired page 14 is retrieved from the memory 13 for display.

As mentioned above, there can be up to 800 pages in one teletext datum. Accordingly, the memory 13 needs a large enough space to store the 800 pages. For one page, at least 25×40 characters are included; that is, one page occupies about 1K-byte memory space. Likewise, 800 pages would occupy at least 800K-byte memory space. Generally speaking, the memory size of an embedded system should be as small as possible. The memory 13, however, requires a large memory space, causing problems for the embedded system. As a result, a solution that is capable of saving memory space is needed in this industrial field.

### SUMMARY OF THE INVENTION

An objective of this invention is to provide a teletext storage device. The teletext storage device comprises a decoder, a compressor, and a memory. The decoder decodes a teletext datum. The compressor compresses the decoded teletext datum. The memory stores the compressed teletext datum.

Another objective of this invention is to provide a teletext storage method. The teletext storage method comprises the following steps: decoding a teletext datum; compressing the decoded teletext datum; and storing the compressed teletext datum.

Another objective of this invention is to provide a display system. The display system comprises a teletext storage device and a monitor. The teletext storage device comprises a decoder, a compressor, and a memory. The decoder decodes a teletext datum. The compressor compresses the decoded teletext datum. The memory stores the compressed teletext datum. The monitor displays a page of the teletext datum retrieved from the memory.

Yet a further objective of this invention is to provide a teletext storage device. The teletext storage device comprises: means for decoding a teletext datum; means for compressing the decoded teletext datum; and means for storing the compressed teletext datum.

The teletext datum is compressed so that the size of the memory of the present invention is reduced.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a conventional teletext storage device;

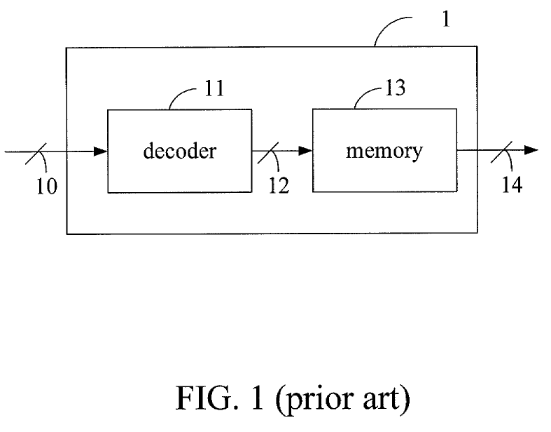

FIG. 2 illustrates a first embodiment in accordance with the present invention; and

FIG. 3 is a flow chart of a second embodiment in accordance with the present invention.

### DESCRIPTION OF THE PREFERRED EMBODIMENT

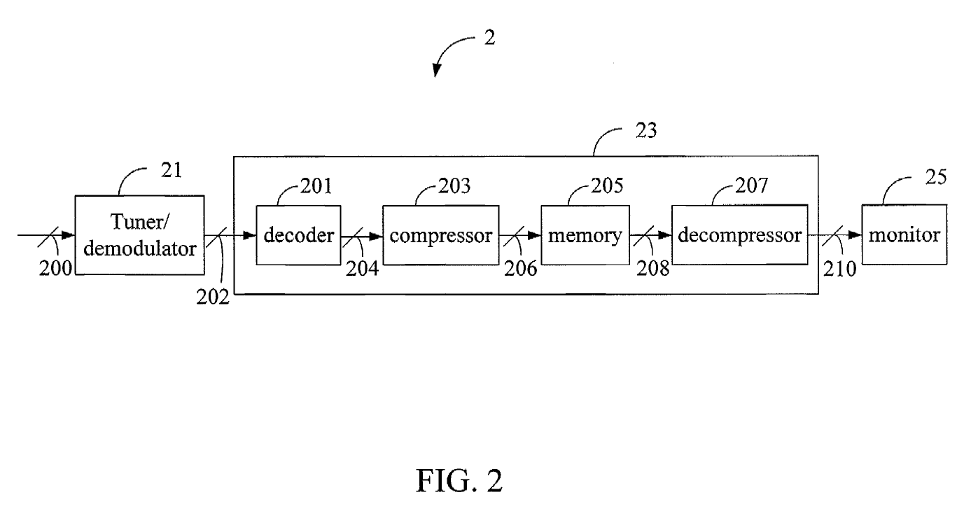

FIG. 2 shows a first embodiment of the present invention, which is a display system 2. In particular, the display system 2 is a digital television. The display system 2 comprises a tuner/demodulator 21, a teletext storage device 23, and a monitor 25. The teletext storage device 23 comprises a decoder 201, a compressor 203, a memory 205, and a decompressor 207. The tuner/demodulator 21 receives a DTV signal 200 and selects one of the TV channels by tuning frequency. Each of the TV channels has its own encoded teletext datum. The encoded teletext datum 202 of the selected TV channel is transmitted to the decoder 201. The decoder 201 decodes the encoded teletext datum 202. Many coding methods have been developed and those skilled in the art are familiar with these coding methods. The present invention does not intend to exclude any of them. The structure of the decoder 201 depends on how the encoded teletext datum 202 is encoded. After decoding, the decoder 201 generates a decoded teletext datum 204.

Then, the compressor 203 compresses the decoded teletext datum 204 to scale down the size of the decoded teletext datum 204. A compressed teletext datum 206 is transmitted to the memory 205 for storage. In addition to storing the compressed teletext datum 206, the memory 205 also stores an indicator to index the compressed teletext datum 206 stored therein.

When a user selects to read a desired page of the encoded teletext 202, the teletext storage device 23 can find the desired page of the compressed teletext datum 206 according to the indicator. The desired page 208 is then retrieved from the memory 205 and transmitted to the decompressor 207. The decompressor 207 decompresses the desired page 208. After that, the decompressed page 210 is transmitted to the monitor 25 for display.

As mentioned above, the methods for coding teletext data are numerous. In the first embodiment, the methods comprises: (1) 7 data bits plus one bit odd parity; (2) 4 data bits plus 4 Hamming protection bits; and (3) 18 data bits plus 6 Hamming protection bits for a triplet. For method (1), the decoder 201 is a parity checker in which single bit errors can be checked. For both methods (2) and (3), the decoder 201 is a Hamming decoder. For method (2), bits 1, 3, 5 and 7 are the protection bits and bits 2, 4, 6 and 8 carry data so that single bit errors can be checked and corrected. Double bit errors can also be checked. For method (3), bits 1, 2, 4, 8, 16, 24 are the protection bits and the remaining bits carry data so that single bit errors can be checked and corrected. Likewise, double bit errors can also be checked.

The compressor 203 and the decompressor 207 execute a lossless compression and decompression, respectively. Lossless compression is a data compression algorithm that allows an exact original datum to be reconstructed from a compressed datum. The lossless compression comprises, for example, a run length encoding (RLE)/run length decoding (RLD), a Huffman coding/decoding, a RAR (according to the name of the inventor, Eugene Roshal, abbreviated from Roshal ARchive) compression/decompression, and a LZH (after Lempel-Ziv and Haruyasu, the inventors) compression/decompression, etc. The RLE uses two bytes to represent more than two repeating consecutive bytes. The fist byte indicates the number of repeated bytes. The second byte indicates what the repeated bytes are.

In the first embodiment, the indicator for indexing the compressed teletext datum 206 is a packet X/0 embedded in the corresponding teletext page, wherein X represents a magazine address value and 0 represents a packet number. The packet X/0 may be used to mark the end of the corresponding teletext page. The teletext storage device 23 searches pages according to the packets X/0.

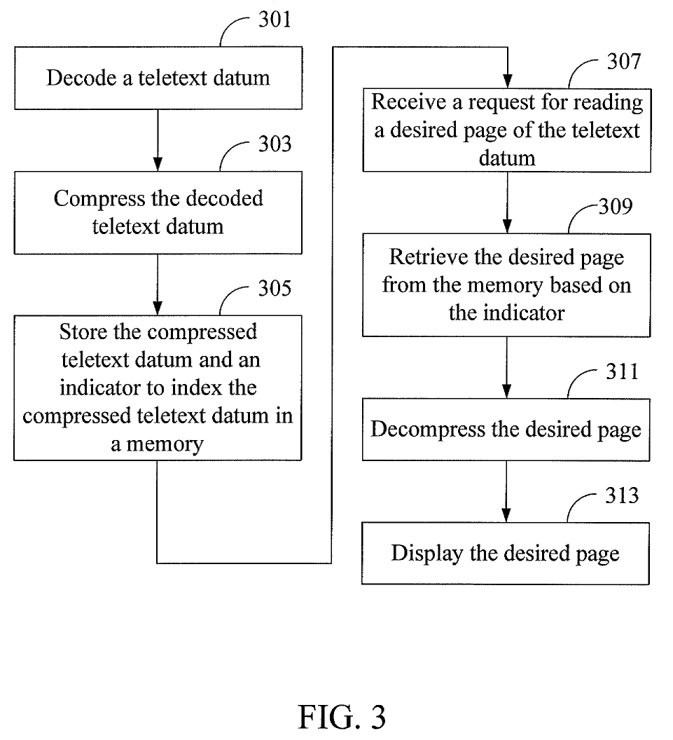

A second embodiment of the present invention is a teletext storage method which is adapted for a teletext storage device, as noted in the first embodiment. FIG. 3 shows a flow chart of the teletext storage method. In step 301, decoding a teletext datum is executed. In step 303, compressing the decoded teletext datum is executed. Step 305 is then executed to store the compressed teletext datum and an indicator to index the compressed teletext datum in a memory. In step 307, a request for reading a desired page of the teletext datum is received. In response to the request, the desired page is retrieved from the memory based on the indicator in step 309. Then, step 311 is executed to decompress the desired page. In step 313, the desired page is displayed.

In addition to the steps shown in FIG. 3, the second embodiment is able to execute all of the operations or functions noted in the first embodiment. Those skilled in the art can straightforwardly realize how the second embodiment performs these operations and functions based on the above descriptions of the first embodiment. Therefore, the descriptions for these operations and functions are redundant and not repeated herein.

The present invention provides a solution for saving memory space so that the memory size for storing teletext data is reduced and, hence, the cost is reduced.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A teletext storage device, comprising:
a decoder for decoding a teletext datum;
a compressor for compressing the decoded teletext datum; and
a memory for storing the compressed teletext datum.

2. The teletext storage device as claimed in claim 1, further comprising a decompressor for decompressing a page of the compressed teletext datum.

3. The teletext storage device as claimed in claim 1, wherein the decoder is a parity checker.

4. The teletext storage device as claimed in claim 1, wherein the decoder is a Hamming decoder.

5. The teletext storage device as claimed in claim 1, wherein the memory further stores an indicator to index the compressed teletext datum stored therein.

6. A teletext storage method, comprising:
decoding a teletext datum;
compressing the decoded teletext datum; and
storing the compressed teletext datum.

7. The teletext storage method as claimed in claim 6, further comprising a step of decompressing a page of the compressed teletext datum.

8. The teletext storage method as claimed in claim 6, wherein the decoding step comprises a step of checking if there is an error in the teletext datum with a parity checker.

9. The teletext storage method as claimed in claim 6, wherein the decoding step comprises a step of checking if there is an error in the teletext datum with a hamming decoder.

10. The teletext storage method as claimed in claim 6, wherein the storing step comprises a step of storing an indicator to index the compressed teletext datum stored therein.

11. A display system, comprising
a teletext storage device, comprising:
a decoder for decoding a teletext datum;
a compressor for compressing the decoded teletext datum; and
a memory for storing the compressed teletext datum; and
a monitor for displaying a page of the teletext datum retrieved from the memory.

12. The display system as claimed in claim 11, wherein the teletext storage device comprises a decompressor for decompressing the page retrieved from the memory before the monitor displays the teletext datum.

13. The display system as claimed in claim 11, wherein the decoder is a parity checker.

14. The display system as claimed in claim 11, wherein the decoder is a hamming decoder.

15. The display system as claimed in claim 11, wherein the memory further stores an indicator to index the compressed teletext datum stored therein.

16. A teletext storage device, comprising:
means for decoding a teletext datum;
means for compressing the decoded teletext datum; and
means for storing the compressed teletext datum.

17. The teletext storage device as claimed in claim 16, further comprising means for decompressing a page of the compressed teletext datum.

18. The teletext storage device as claimed in claim 16, wherein the decoding means further checks if there is an error in the teletext datum with a parity checker.

19. The teletext storage device as claimed in claim 16, wherein the decoding means further checks if there is an error in the teletext datum with a hamming decoder.

20. The teletext storage device as claimed in claim 16, wherein the storing means further stores an indicator to index the compressed teletext datum stored therein.
